(19) United States
(12) Patent Application Publication
(10) Pub. No.: US 2003/0110644 A1
(43) Pub. Date: Jun. 19, 2003

(54) Universal fork

(76) Inventor: Michael D. Miller, Wichita, KS (US)

Correspondence Address: Bradley P. Sylvester, Suite 100, 225 N. Market Street, Wichita, KS, 67202, US

(21) Appl. No.: 10/020,739

(22) Filed: Dec. 18, 2001

(51) Int. Cl. A47J 43/28

(52) U.S. Cl. 30/322; 30/148

(57) ABSTRACT

This improved universal fork is a combination of the particular functions and characteristics of a knife and a fork, and is capable of being used with either a right hand or left hand, and also has benefits for those with disabilities. The balanced handle provides a counter weight to the head area of the fork, as well as provides a greater surface which is able to fit and press against the palm of a person's hand.

The improved universal fork has a head area that has outer tines which have an outer edge curvature that is exaggerated, as compared with other typical forks. The outer curved edge may be dull, have a sharpened blade edge, or it may have a serrated edge. These edges may be in combination on a single edge, or be used alternatively on the opposing outer tines. The curved outer edges provide an increased cutting capability, using a rocking motion.

A finger platform, being a defined flattened area immediately adjacent to the head portion of the fork, allows a person to easily press one or more fingers against the side area of the fork, thereby applying pressure directly downward when the fork is positioned to cut an item directly beneath it.

### BACKGROUND OF THE INVENTION

Prior art tends to fall into two relevant categories. First, various eating utensils have been developed in order to assist those with various impairments or physical disabilities. Second, efforts have been made to combine various features of multiple utensils into a single utensil item. The present invention takes both of the major concerns, as well as the concern that this utensil not be suitable for use as a weapon.

Where eating utensils are intended to, or have a primary function for, use by persons with physical disabilities, the utensil itself tends to be defined by various physical attributes for the gripping or manipulation of the utensil. The physical construction of such a utensil typically allows for an exaggerated surface area in which the user is able to grip or press against, to allow greater ease during the use of such a utensil. The present invention also offers such attributes that had not been previously shown in the prior art.

Where eating utensils are a combination of various features into a single novel item, the attempt of the inventor generally is to allow a single eating utensil to take place of one or more separate utensils. In some instances, different utensils are physically combined with one another, and another instances, various features are combined. Examples of prior art utensils that are intended to assist disabled persons are evidenced in U.S. Pat. No. 5,481,805 (Wilson), in which the handle portion of a fork was both curved and flared.

A wedge shaped eating utensil is shown and described in U.S. Pat. No. 5,058,279 (Mars). The handle itself allows the eating utensil to be more easily held by persons with motor skill disabilities. In addition, in U.S. Pat. No. 5,060,386 (Mars), an eating utensil is shown, in which the handle portion itself and placement of the utensil head allow a person with limited wrist movement to use an eating utensil with greater ease. Further, in U.S. Pat. No. 5,068,967 (Mars), a cylindrical handle eating utensil was described, which was intended for use by people with physical disabilities.

Eating utensils have also been contrived in an attempt to combine two or more different utensils into a single unit. In U.S. Pat. No. 4,835,864 (Tang), a combination of a fork and a spoon is shown, in which both implements were able to be used on a single handle through the actions of moving various utensil heads into a dominate position. Similarly, in U.S. Pat. No. 4,922,611 (Levy), a multi head utensil was disclosed, in which separate knife, fork and spoon members are incorporated into a single handle.

Other structures have been added onto existing utensils. In U.S.. Pat. No. 5,697,160 (Pritsker), an eating utensil for pasta is shown. This invention shows the novelty of incorporating a shield into an eating utensil, to allow the spinning fork, used in conjunction with it, to guide pasta noodles around fork tines. Othertimes, the structure of the utensil has been altered for other uses, In U.S. Pat. No. 6,199,285 (Sheehan), a foldable handle is shown with an eating utensil.

U.S. Pat. No. 5,592,744 (Weinstein) and U.S. Pat. No. 5,630,276 (Weinstein) disclose eating utensils that have a self leveling spoon, using reciprocating weights to manipulate the angle of the spoon head.

Other inventors have sought to maintain a single utensil head, with modifications to attempt to incorporate multiple uses into it. In U.S. Pat. No. 2,473,288 (McNeill), a combination fork and spoon was disclosed, in which the spoon attributes were accomplished through a concave formation of the utensil head. A slightly serrated side edge allows the single utensil to also form a cutting instrument. One drawback to this invention was that there was no formational change to the utensil itself to make gripping or cutting any easier for the user.

U.S. Pat. No. 2,216,005 (Goldstein) disclosed a combination spoon and fork, in which a spoon like head was provided with defined sharp points, so that it could both impale food and support liquid type foods in the spoon portion. A more advanced adaptation of this spoon is seen in U.S. Pat. No. 4,535,538 (Nelson), which is a precursor of what is more commonly recognized as a “spork”. This invention is more commonly seen through the utensil shown in U.S. Pat. No. Des. 388,664, the “spork”. A further development on the “Spork” concept is shown in U.S. Pat. No. 4,984,367 (Albanese), in which a cutting means was also included on the head or implement portion. A recess, designated by the number 6, was also provided, which would allow a user's finger to be properly positioned for cutting. The recess did not appear to have any function other than a guide for the finger, and did not present a suitable platform for pressing the user's finger against. In U.S. Pat. No. Des. 376,514 (Torkelson), further ornamental modifications on what is known as a “Spork” are shown.

The use of a fork, as the primary utensil from which other advantages are incorporated, is shown in U.S. Pat. No. 4,771,541 (Bouchakian). In this invention, the benefits of a fork and a knife were combined. This particular invention was depicted as having use with only one hand, being in the right hand as the figures show. A single tab, and a single cutting edge were used. The present invention does not provide a tab, but rather has the handle formed to provide a surface against which a user's fingers may press. In addition, the present invention is intended for use by either the right or left hand, and would be more suitable for uses on such things as airline flights, or cafeteria style foods, in which the utensils are provided in quantity, and without having to be concerned with which orientation a person will require.

U.S. Pat. No. 6,119,351 (Vanderputt) discloses a beveled edge fork, in which cutting edges are available on both sides of a fork utensil. What this invention lacks, is a superior surface against which a user's finger can press against when cutting. While this prior art invention attempts to provide multiple uses for persons having either right or left hand orientation, there still lacks the ease in which a person can use the utensil as a knife. Further, there is also a lack of balance of mass from end to end of this utensil. Both concerns are met and addressed by the present invention.

With the concerns of having a utensil modified into a weapon, some attempts to limit such modifications have been shown. The multiple simultaneous hijackings of U.S. aircraft on Sep. 11, 2001, have prompted consumers and commercial carriers to reevaluate what type of implements may be distributed to passengers, with the primary concern being whether or not the implement may be converted as is into a weapon. In some instances, the traditional “spork” is inadequate for various food items. There have been attempts made to reduce this threat. In U.S. Pat. No. 4,610,087 ( Mickelson et al.), a utensil is shown in which a primary feature of said utensil is that it has a reduced ability to be turned into a weapon. The present invention addresses the need to have a separate fork and knife during a cutting process, through rounded outer edges of the present invention, that do not require a sawing back and forth over a food item to cut through it. Rather, the present invention can accomplish appropriate cutting of food through a rocking motion.

### DESCRIPTION OF THE FIGURES

FIG. 1 is a top view of the improved universal fork.

FIG. 2 is a side view of the improved universal fork.

FIG. 3 is a side view of the finger platform portion of the improved universal fork.

FIG. 4 is a perspective view of the improved universal fork as it is held by any person's hand during the cutting process.

FIG. 5 is a perspective view of the fork tines and the edge of the outer tine.

FIG. 6 is a perspective view of the fork tines showing a sharpened edge.

FIG. 7 is a perspective view of the fork tines showing a serrated edge.

FIG. 8 is a top view of the pointed end areas of the center fork tines.

FIG. 9 is an enlarged view of the inner and the outer fork tines, showing the additional width defined by the curved outer edges of the outer fork tines.

### SUMMARY OF THE INVENTION

This improved universal fork is a combination of the particular functions and characteristics of a knife and a fork. The improved universal fork is comprised of a balanced handle, having an enlarged end that both provides a counterweight to the head area of the fork, as well as provides a greater surface which is able to fit and press against the palm of a person's hand, which is particularly useful when using the improved universal fork as a knife.

The improved universal fork has a head area that is comprised of both outer and inner fork tines. The inner fork tines have a shape consistent with a typical fork that is commonly used, but the outer tines have increased thickness and an outer edge curvature that is exaggerated as compared with other typical forks. The outer curved edge may be dull, in that it does not have an intentionally sharpened outer edge, or it may also be defined as having a sharpened outer edge, or it may also comprise a serrated edge.

The cutting potential of this improved universal fork is much greater than other forks that have preceded it. The curved outer edges provide an increased cutting capability, as the head of the fork is able to rock back and forth over an item desired to be cut, which greatly increases the cutting potential of a sharpened edge, a serrated edge, or even a dull edge.

The cutting potential of this improved universal fork is further increased through the design of the handle itself. Although the handle defines an enlarged end that is able to press against a person's palm, the handle also defines a finger platform as an expanded height of the handle immediately adjacent to the head portion of the fork, which defines a flattened surface immediately adjacent to the head of the improved universal fork. The finger platform allows a person to press one or more fingers against the side area of the fork, thereby applying pressure directly downward when the fork is positioned to cut an item directly beneath it.

This particular fork may also be provided with beveled tine ends, having an angled blade edge, which increase the sharpness of the tine ends, but also decreases the overall width of the tine ends, and thus their strength and resistance as to breakage. These modified tine ends allow the improved universal fork to have a limited potential for use as a weapon, when the improved universal fork is constructed out of a plastic or similar material. The narrowed tine ends will break off under a shearing pressure, which has the effect of limiting the potential of the improved universal fork as a pointed weapon, since the first use of it in this manner will cause a portion of the tines to break off, without being able to impact severely into a victim's body, rendering the tines to be significantly dulled as to future use.

This improved universal fork has the capability of being provided for use to persons having either a right-handed or left-hand orientation, since the improved universal fork sides are capable of, and intended to be mirror images of each other. Therefore, the finger platform on one side of the improved universal fork will be a mirror image of the finger platform on the opposite side of the improved universal fork.

The improved universal fork has the potential to be offered to travelers on commercial carriers during mealtime, with a limited concern about this improved universal fork being used or converted into a weapon. Because the improved universal fork offers such superior cutting ability, the outer side edges of the outer tines do not need to be overly sharp, or the improved universal fork is constructed out of a fairly rigid material, such as metal or hard plastic. A weaker overall material may be used, in which case the outer edges and have increased sharpness or serrated edge. In such a configuration, an improved universal fork with a sharpened or serrated edge will have an increased cutting ability, but less overall strength, and will therefore present less of a threat as a weapon. Such a utensil will provide increased security to carriers such as airlines, who are attempting to protect their passengers from other persons who have an intent to convert an item into a weapon and hijack a plane.

The improved universal fork further also offers benefits to persons having motor skill disabilities, or use of a single hand, or any situation where the trading off of a fork and a knife are impractical. In such a situation, the enlarged handle allows easier gripping, and the improved universal fork provides all aspects of both a fork and a knife as a single utensil. The increased area of the finger platform allows a disabled user to more readily have access to the necessary points along the length of the improved universal fork, during cutting of food.

Is therefore an objective of this invention to provide a single utensil that is capable of providing the benefits of a knife and a fork into a single utensil.

It is a further object of this invention to provide a single utensil that is capable of being used as a fork, but which also has a curved outer side edge that allows it to be used more easily for cutting food.

It is a further object of this invention to provide a single utensil that is provided with a finger platform that allows the user's finger to press against it during use of the utensil as a cutting instrument.

It is a further object of this invention to provide a superior utensil that exhibits properties that are not conducive to it being converted into a weapon.

Is a further object of this invention to provide a single utensil that is able to be used as both a knife and a fork, whereby persons with motor skill disabilities are more able to use the utensil, and still be able to cut food without the normally prerequisite back and forth sawing process, through the rocking motion of the curved outer edges on the food.

### DESCRIPTION OF THE PREFERRED EMBODIMENT

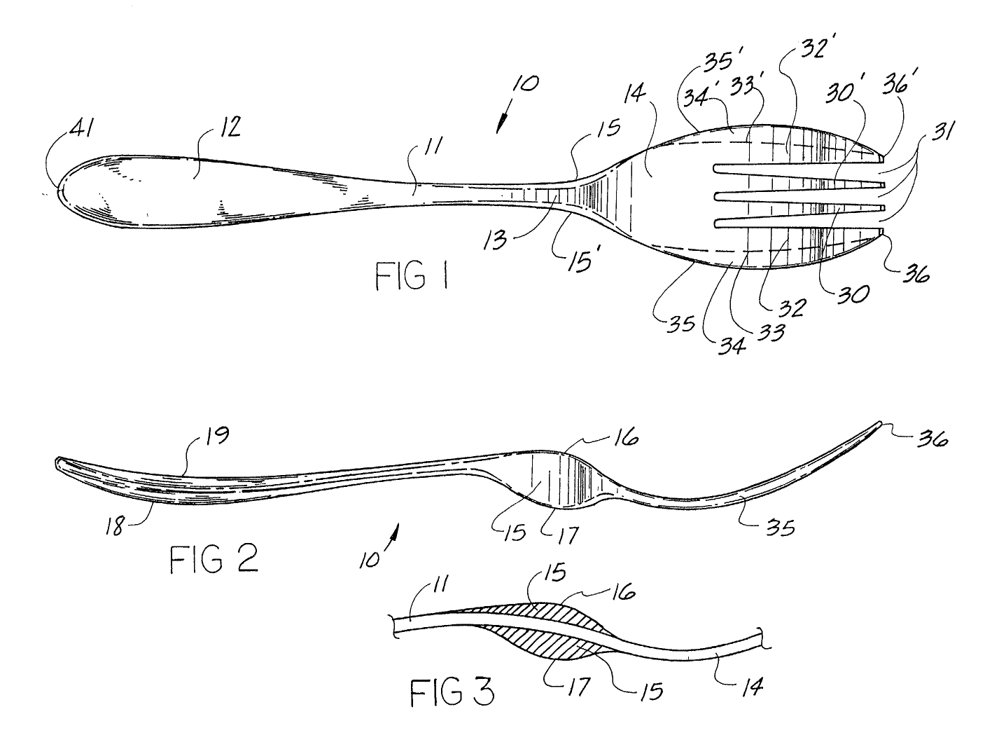

Referring now to FIG. 1, a top view of the improved universal fork 10 (hereinafter referred to as “fork 10”) is shown. The fork 10 is comprised of a handle grip 12, that has a generally curved outer shape, that is somewhat flattened on its upper 19 and lower 18 surface, and which increases in circumference along its length from the central handle shaft 11 to its terminating end 41. The length of the handle grip 12 may follow an upward arc, as is more clearly seen in the side view of FIG. 2. The increased surface area of the handle grip 12, and upward curvature allows persons with motor skill disabilities to more easily grip the handle, as compared with typical fork handles.

The central handle shaft 11 is the narrowest portion of the fork 10, as seen from a top view, and is defined the length of the handle between the handle grip 12 and the point where the fork head is joined to the shaft 11. At the point where the handle is joined to the fork head, the sides of the handle shaft 11 deform, causing an increased height of the shaft 11, so that the top side 16 of the shaft raised upward, which the bottom side 17 defines a protrusion downwards. While the height of the shaft 11 increases, being the distance between the top 16 and bottom 17 sides, the width of the shaft does not appreciably change, defined by the flat areas 15 and 15′, which comprise the finger platforms.

Referring now to FIG. 1 and 2, each finger platform is comprised of a flattened surface 15 and 15′ respectively, defined by a top side 16 and bottom side 17, in which the height of the handle is increased, as shown in FIG. 2. The width of the handle shaft 11 is not increased in proportion to the height increase, being the distance between the top 16 and bottom 17 surface. The flattened surfaces 15 and 15′ are located along the length of the handle at the point where the shaft 11 is joined to the fork head.

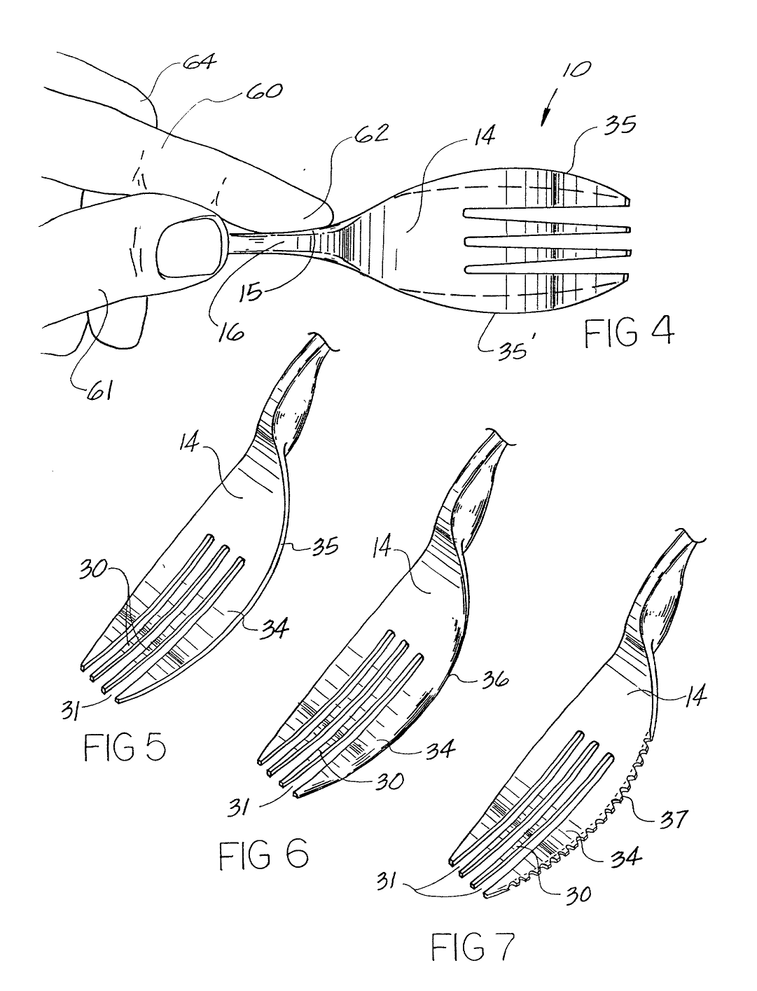

To more clearly realize the novelty of the finger platform, FIG. 3 indicates a typical fork handle 14 that is generally of a uniform thickness. As FIG. 3 depicts, the improved universal fork 10 has added material to cause a bulging of the shaft top 16 and bottom 17 side surfaces, in a manner in which a flat surface 15 is able to be defined to provide an area commensurate with the area that a typical forefinger fingertip 62 will contact, as shown in FIG. 4. This added material, as compared with a typical fork handle 14, creates the finger platform upon which a person's finger can press against. This finger platform allows a person to utilize the cutting edges of a fork 10 more efficiently through the distribution of forces from the finger to the fork.

The cutting areas of this fork 10 that are capable of functioning as a knife are found on the outer edges 35 and 35′ of the outer tines 32 and 32′. Moving forward from the finger platform area, the handle shaft 11 expands outward from side to side forming a fork head 14 that defines a plurality of forward protruding tines. Preferably, there are two separate inner tines 30 and 30′, which are spaced and positioned between outer tines 32 and 32′. Both the inner tines 30 and 30′ and outer tines 32 and 32′ are parallel to each other, and follow the same curved plane, as is shown in FIG. 2. The inner tines 30 and 30′ comprised rigid shafts that exhibit an upward curvature as shown in FIG. 2, with tines 30 and 30′ being parallel to one another. Said tines 30 and 30′ are separated from each other by gaps 31. Also, inner tines 30 and 30′ are each separated and spaced apart from outer tines 32 and 32′, defining a gap 31 between said inner 30 and 30′ and outer tines 32 and 32′.

As seen from a top view, such as shown in FIG. 1, a fork 10 having an enlarged handle grip 12 is shown, with the outer tines 32 and 32′ exhibiting an exaggerated widened portion, as compared with a typical fork. A typical fork outer tine has an outer edge as shown by dashed line 33 and 33′. The improved universal fork 10 has incorporated an extended outer edge area 34 and 34′, which comprises an extended width of the outer tine 32 and 32′, having a curved outer edge 35 and 35′. The curved outer edge 35 and 35′ follows an arcual path, and will comprise a curved surface arcing thirty degrees or more. As FIG. 9 shows, the curvature may even approach or exceed ninety degrees of curvature, when defining the first curvature vector 44 as the start of the arcual outer edge 35 where it protrudes outward from the head 14, with the second vector being the edge angle at the tip 66 of the outer tine 32.

It is the curvature of this outer edge 35 and 35′ that give this fork 10 its superior cutting abilities. Referring now to FIG. 5, the outer edge 35 may be comprised of a non sharpened or dull edge. Greater cutting abilities may be realized if the outer edge is sharpened to give it a blade edge 36, as shown in FIG. 6. The defined blade edge 36 may comprise the entire, or merely a portion of the outer edge area 34. In the alternative, a serrated edge 37 may also be defined on the outer edge area 34, as depicted in FIG. 7. The outer edges 35 and 35′ may differ in their edges, so that the fork 10 has a combination of outer edges 35 and 35′ that are dull and sharpened, dull and serrated, or sharpened and serrated. Preferably, a blade edge 36 or a dull edge 35 is used, since the curvature of the edges 35 and 35′ allow for a smooth cutting, and not for a sawing motion which is most beneficial for serrated edges. Where the dull edge 35 is used, this fork 10 has less chance of being converted into a weapon in an undesired manner, since there is no true blade edge 36.

Even with a dull edge 35, this fork 10 is able to satisfactorily function as a knife, when dealing with food items. The reason for this is that the exaggerated curvature of the outer dull edge 35, as shown in FIG. 5, is able to rock backwards and forwards over a food item, maximizing the downward pressure applied with a fork 10 into a small area of fork contact with the food. The rocking motion further benefits the cutting due to the slicing of even a dull edge 35 against the food item. As a result of the curvature, there is never more than a small portion of the edge 35 in contact as a cutting instrument with food at any given time, allowing all of the cutting force to be applied to a smaller region of food. Clearly, where a blade edge 36 is used, the ability of this fork 10 to cut food items is even more enhanced. The curved blade edge 36, when rocked back and forth over food items, will provide quick and easy cutting.

An increased ability for this fork 10 to function as a cutting instrument is enhanced by the finger platform flat edge area 15. Referring now specifically to FIG. 4, a person's hand is shown, in which a fork 10 has been rotated ninety degrees from its typical resting position, as shown in FIG. 1, with the thumb 31 and middle finger 64 grasping the handle of the fork 10 on its top 16 and lower 17 surface respectively. The forefinger 60 is able to press against the finger platform flat area 15 with its fingertip 62, thereby imparting a downward pressure into the length of the fork 10, with the forward portion of the handle and head of the fork 10 functioning as a lever, with the handle 12 being the fulcrum. The downward pressing force applied by the fingertip 62, is transferred to the outer edge 35′ of fork 10. Through simple upward and downward rotational movement of the person's hand, the outer edge 35′ will be able to rock back and forth over food items desired to be cut.

As is evident in these figures, each side of the fork 10 is a mirror image of the other. Therefore, the same fork 10 is able to be used by the right hand or left-handed person. The outer edge 35′ is functional with a person's left-hand usage, while outer edge 35 would be functional with a person's right hand.

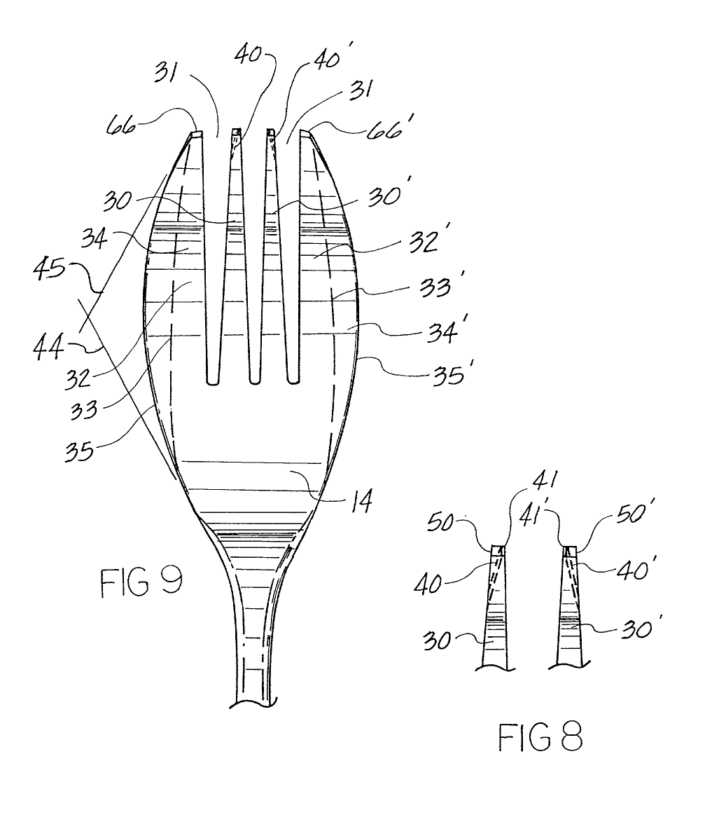

Referring now specifically to FIG. 8 and FIG. 9, the inner tines 30 and 30′ are shown, in which said tines 30 and 30′ may have increased sharpness, resulting in a more defined point 41 and 41′. The outer surface shape of a typical inner tine 30 and 30′ is shown by surface 50 and 50′. The modified surface is indicated by dashed lines 40 and 40′, which represents a typical angular shaping of the tines 30. When the tines 30 are given an angled tip in this manner, there is a diminished overall width of the inner tines 30 and 30′ near their points 41 and 41′. Since the overall width is lessened, the overall strength of these tines 30 and 30′ is diminished. When using a material such as a plastic polymer, the plastic strength can be determined in appropriate level so that if any unusual amount of shearing force is applied to these modified sharpened tines 30 and 30′, the points 41 and 41′ will break off when there is insufficient support to sustain the shearing force. In this manner, the tips 41 and 41′ will break off leaving a dulled tine 30, which makes this fork an insufficient convertible weapon.

The fork 10 may be constructed out of any resilient material, comprising metal, plastics, resins, or natural products such as wood.

From the foregoing statements, summary and description in accordance with the present invention, it is understood that the same are not limited thereto, but are susceptible to various changes and modifications as known to those skilled in the art and we therefore do not wish to be limited to the details shown and described herein, but intend to cover all such changes and modifications which would be encompassed by the scope of the appended claims.

I claim

1. An improved universal fork comprising:
a. a handle shaft, having a back end that enlarges in circumference along its length toward the back end, where said handle shaft also has a front end that is joined to a fork head;
b. a fork head having inner and outer tines, where said outer tines define curved outer edges;
c. a finger platform, on each side of the handle, comprising a deformation of the handle shaft at the point where the handle is joined to the fork head, where said finger platform defines an enlarged flat side surface against which a person's forefinger is able to press against.

2. An improved universal fork, as recited in claim 1, in which the sides of the handle and finger platform flat areas are symmetrical to each other.

3. An improved universal fork, as recited in claim 1, in which the fork head comprises outer tines that form sides of the fork head which are symmetrical to each other.

4. An improved universal fork, as recited in claim 1, in which the sides of the handle and finger sides are symmetrical to each other.

5. An improved universal fork, as recited in claim 1, in which the improved universal fork is constructed out of metal.

6. An improved universal fork, as recited in claim 1, in which the improved universal fork is constructed out of plastic.

7. An improved universal fork, as recited in claim 1, in which the improved universal fork is constructed out of resin.

8. An improved universal fork, as recited in claim 1, in which the fork head comprises inner tines and outer tines, and where the inner tines have angled sharpened ends, with the end portions of the inner tines having a decreased circumference, so that the tips will break off when a shearing stress is applied to them.

9. An improved universal fork, as recited in claim 1, in which the outer tines define an unsharpened dull edge.

10. An improved universal fork, as recited in claim 1, in which the outer tines define a blade edge.

11. An improved universal fork, as recited in claim 1, in which the outer fines define a serrated edge.

12. An improved universal fork, as recited in claim 1, in which one of the outer tines define a serrated edge, and the other outer tine defines a sharpened blade edge.

13. An improved universal fork, as recited in claim 1, in which one of the outer fines define a dull edge, and the other outer fine defines a sharpened blade edge.

14. An improved universal fork, as recited in claim 1, in which one of the outer tines define a dull edge, and the other outer tine defines a sharpened blade edge.

15. An improved universal fork, as recited in claim 1, in which both of the outer tines define a serrated edge.

16. An improved universal fork, as recited in claim 1, in which both of the outer tines define a dull edge.

17. An improved universal fork, as recited in claim 1, in which both of the outer tines define a sharpened blade edge.

18. An improved universal fork, as recited in claim 1, in which the outer tine defines an outer edge that has a portion of the edge defined as a serrated edge.
